(19) United States
(12) Patent Application Publication
(10) Pub. No.: US 2026/0285500 A1
(43) Pub. Date: Sep. 24, 2026

(54) AIRCRAFT ENGINE DIAGNOSTIC SYSTEM WITH RETROREFLECTORS

(71) Applicant: General Electric Company, Evendale, OH (US)

(72) Inventor: Phillip Schultz, Cincinnati, OH (US)

(21) Appl. No.: 19/085,143

(22) Filed: Mar. 20, 2025

(51) Int. Cl. B64D 45/00; B64D 33/00

(52) U.S. Cl. CPC B64D 45/00; B64D 33/00; B64D 2045/0085

(57) ABSTRACT

An aircraft engine diagnostic system includes an aircraft engine, a high-speed imaging device, an illumination source, a processor, and a memory. The system projects light from the illumination source towards a first fan blade at an incidence angle of up to 60 degrees to reflect at least a portion of the projected light from a retroreflector towards the high-speed imaging device at a reflected angle aligned with the incidence angle. The high-speed imaging device receives the reflected light as retroreflective light to determine a signal based on an amount of the retroreflective light received and a state of the first fan blade based on a comparison of the signal with a signal threshold. The system generates an output indicating the first fan blade is in a predetermined state when the signal exceeds a signal threshold to selectively change the state of the first fan blade.

### TECHNICAL FIELD

The present disclosure relates to aircraft engine diagnostic systems, and more particularly, to aircraft engine diagnostic systems for imaging engine components with retroreflectors.

### BACKGROUND

There are multiple aircraft engine components that undergo manufacturing and/or ground evaluation (e.g., engine diagnostics). For instance, an aircraft engine must be evaluated to ensure proper functioning, compliance with regulations, and/or readiness for flight. Such ground evaluations analyze the dynamics of fan blades, including their bending, twisting, and/or vibrational characteristics in order to validate aerodynamic performance for flight operations.

Challenges may arise for a ground evaluation where fan blades rotate at high speeds in low light conditions, making it difficult to capture motion accurately in real-time. Generally, such tracking systems must be capable of handling high-speed rotations and rapid changes in blade position without introducing measurement errors or delays. Additional challenges may arise with the need for additional lighting equipment, which can become costly and consume significant energy to properly illuminate the fan blades during evaluation and/or manufacturing.

Accurately capturing high-speed motion presents further challenges beyond lighting and measurement. For example, environmental factors such as temperature fluctuations, airflow disturbances, and particulate matter can introduce additional inconsistencies in high-speed imaging and/or data collection. The presence of dust, debris, and reflective surfaces may interfere with optical tracking, requiring careful consideration of imaging placement and/or calibration. Moreover, fan blades in gas turbine engines may exhibit complex contours having intricate geometries, which present challenges for high-speed imaging and tracking as conventional optical systems have difficulty capturing accurate data across varying angles and curvatures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a schematic view illustrating an aircraft engine diagnostic system imaging fan blades of an engine in accordance with the aspects of this disclosure;

FIG. 2 is a block diagram of a controller of the system of FIG. 1;

FIG. 3 is a perspective view illustrating the aircraft engine diagnostic system of FIG. 1, the view illustrating an illumination device and a high-speed camera of the aircraft engine diagnostic system imaging retroflectors of the aircraft engine diagnostic system, the retroreflectors shown associated with fan blades of the aircraft engine diagnostic system of FIG. 1;

FIG. 4 is an exemplary flow diagram of a method of evaluating a aircraft component with the aircraft engine diagnostic system of FIG. 1 in accordance with aspects of this disclosure; and

FIG. 5 illustrates exemplary retroreflector angular response data.

### DETAILED DESCRIPTION

Although this disclosure will be described in terms of specific aspects, it will be readily apparent to those skilled in this art that various modifications, rearrangements, and substitutions may be made without departing from the spirit of this disclosure.

For the purpose of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the features illustrated herein, and any additional applications of the principles of this disclosure, as illustrated herein, which would occur to one skilled in the relevant art and having possession of this disclosure, are to be considered within the scope of this disclosure.

Approximating language, as used herein, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

A common challenge in high-speed imaging is the necessity for high intensity light to guarantee detection of a signal. This issue is compounded by the limitations of modern imaging devices, as sensor arrays therein may have limited time to collect light before their shutter captures a frame.

During high-speed imaging of aircraft engines, (e.g., during ground evaluation), a customary practice is to paint the fan blades in assorted colors, which may be arranged in specific patterns based on the evaluation required. However, this practice contains several pitfalls which can affect the accuracy of the vibration measurements and the overall integrity of the fan blades. For example, even a thin layer of paint can add weight to the fan blades, potentially altering their mass distribution. Moreover, uneven application of paint can lead to imbalance in the engine, which can induce additional vibrations and skew the evaluation results, and even impact lift and drag forces. Further, such paint may be inconsistent and can wear off or chip, requiring frequent reapplication and which can be time-consuming and costly. Furthermore, alternatives such as strain gauges, optical lasers, and dyes typically require the use of additional bulky, expensive, and energy-intensive equipment.

To improve light intensity for high-speed imaging, retroreflectors may be placed on any component of interest. Retroreflectors are passive, optical reflectors designed to reflect light directly back to an illumination source from a wide range of incident angles with minimal scattering, regardless of the angle of incidence. This unique property makes retroreflectors incredibly useful in various applications where visibility and detection are critical, as they are both consistent and predictable in their reflective properties. Retroreflectors employ optical structures including, for example, corner cube retroreflectors, glass bead retroreflectors, and/or full cube retroreflectors, which can be implemented in various form factors, such as different dimensions (e.g., flat sheets, curved or molded shapes, and/or three-dimensional structures) and/or materials (e.g., plastic, glass, metal, and/or flexible polymers. For example, retroreflectors may be implemented in the form of tape, rigid panels, and/or various paints.

This disclosure details utilizing a high-speed camera and an illuminating light source, which may be aligned with the camera receiving optics (e.g., colinear), to image retroreflectors associated with components of an aircraft such as fan blades of an aircraft engine. The illuminating light source may project incident light on the retroreflectors, which reflect light (e.g., retroreflective light beams) back to the light source with some divergence. In doing so, at least a portion of the divergent retroreflective light beams are recorded by the high-speed camera, which enables specific parts of a component to appear to have a significantly higher intensity of reflected light compared to diffuse or specular reflecting surfaces. In some instances, retroreflectors may reflect light back at interrogation angles up to about 60°.

Retroreflectors provide numerous benefits over traditional reflection technology used in ground evaluation (e.g., testing) and/or manufacturing. Overall, the use of retroreflectors leads to longer range, high-speed camera implementations, higher speed imaging, and more efficient component tracking for machine learning and/or digital tracking applications.

Retroreflectors produce higher quality imaging and tracking at a decreased cost. For example, retroreflectors enable the use of higher speed frame rates, improved high-speed object tracking, and higher intensity visuals without the need for additional equipment, eliminating the need for expensive, energy-intensive illumination. Further, as the retroreflectors are passive, they reduce the required power consumption.

In addition, retroreflectors also offer a simple solution that is easy to implement. For example, as retroreflectors receive and reflect light in the same location, they are easy to install and/or align. Based on the variety of structures available, retroreflectors also provide a broad optical bandwidth, providing flexibility in the illumination source chosen. Further, such structures are often designed to conform to the shape of the surface upon which they are affixed with minimal adjustments needed.

Moreover, retroreflectors provide a variety of safety benefits during ground evaluation and/or manufacturing. For example, higher reflected intensity enables longer range recording. Thus, an individual evaluating an aircraft engine may do so at a farther, safer distance from the operating aircraft to avoid injury from moving parts. Further, retroreflective light tapers off of a predictable angle, which an individual may use to avoid viewing the retroreflective light, preventing potential eye damage during evaluation. In addition, retroreflectors may serve to alert individuals within the evaluation area of various moving components, thereby maintaining vigilance during operation when an individual must remain within a close distance to the operating site. Further, the illumination source may require significantly less power consumption and/or intensity. Moreover, retroreflectors offer reduced operational setup and costs from an energy usage and/or environment, health, and safety (EHS) protocol perspective.

The aircraft engine diagnostic systems herein incorporate retroreflectors on components of an aircraft engine (e.g., fan blades). The retroreflectors described herein are adapted to the complex contours of the components (e.g., profiles of the fan blades), thereby enabling precise, real-time imaging without compromising airflow dynamics. By conforming to the component's shape and minimizing optical distortions, the retroreflectors enhance the accuracy of vibration analysis, performance monitoring, and/or predictive maintenance in aircraft engines such as gas turbine engines.

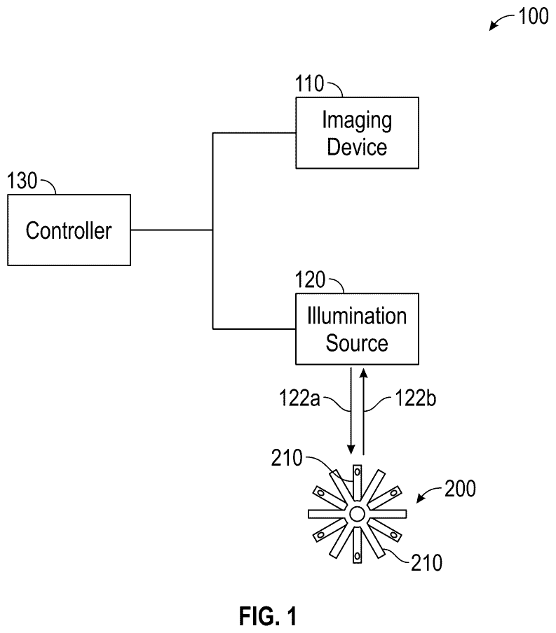

FIG. 1 illustrates an aircraft engine diagnostic system 100 that evaluates an aircraft engine 200 for proper functioning, compliance with regulations, and/or readiness for flight. Although the component being evaluated can be any suitable aircraft component, the aircraft engine 200 is described herein in connection with an aircraft engine in the interest of brevity. For example, the aircraft engine 200 can be a gas turbine engine such as an open fan, although any suitable gas turbine engine may be provided.

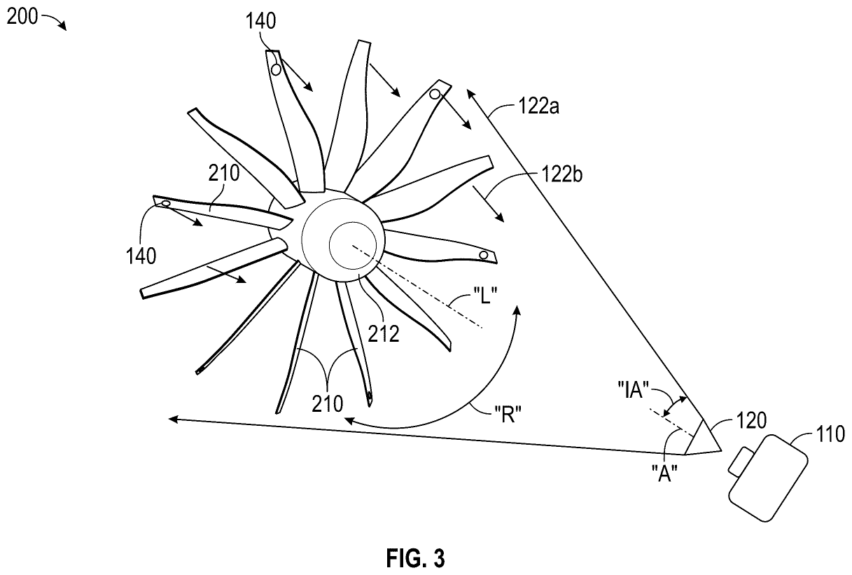

The aircraft engine diagnostic system 100 includes an imaging device 110 (e.g., high-speed imaging device) configured to capture image data, an illumination source 120 configured to transmit light, a controller 130 in electrical communication with the imaging device 110 and the illumination source 120, and a retroreflector 140 (shown in FIG. 3) configured to reflect light from the illumination source 120 and which is attachable to the aircraft engine 200 via any suitable securement technique such as adhesive, welding, friction-fit, etc.

Imaging device 110 of aircraft engine diagnostic system 100 (e.g., a camera) is generally an image sensor configured to convert light into electrical signals, enabling the capture of high-speed images/image data of, for example, rotational speeds and/or vibrations of aircraft engine 200 or one or more components thereof such as fan blades, which produce detailed, high-resolution images/data for analysis. For example, imaging device 110 may be a charge-coupled device (CCD) sensor, complementary metal-oxide-semiconductor (CMOS) sensor, infrared (IR) sensor, multispectral sensor, hyperspectral sensor, and/or other similar high speed imaging capable system. As defined herein, “high-speed” includes a frame rate of at least 60 frames per second (fps), which is significantly faster than standard frame rates used in conventional imaging. Imaging device 110 may be configured to capture both still and fast-moving images, including high-definition videos. For example, imaging device 110 may track the motion of one or more components (e.g., fan blades 210) of aircraft engine 200 during ground evaluation and/or manufacturing to analyze vibration data of such components for determining if such vibration data exceeds predetermined thresholds, is unsuitable for flight, and/or requires maintenance or replacement. In aspects, imaging device 110 may be synchronized with an operational cycle of aircraft engine 200 (e.g., a full or partial rotation of a fan blade 210 about a longitudinal axis “L” defined by aircraft engine 200, as indicated by arrows “R” shown in FIG. 3) to correlate captured images with specific rotational positions and/or speeds of aircraft engine 200 and/or one or more components (e.g., fan blades 210) thereof.

Imaging device 110 of aircraft engine diagnostic system 100 may include an industrial camera with high frame rates, resolution, and robustness. For example, imaging device 110 may include any high-speed camera, e.g., 60 fps (frames per second), 120 fps, 250 fps, and/or higher. In aspects, the camera and/or imaging device 110 may communicate with controller 130 and/or a network to upload ground evaluation and/or manufacturing data to a secondary device, such as a remote computing device like a server or mobile device (not shown), for further analysis.

Illumination source 120 of aircraft engine diagnostic system 100 is configured to be aligned with an optical axis “A” (shown in FIG. 3) of imaging device 110 during imaging to maximize image quality (e.g., directly aligned or slightly offset). Generally, illumination source 120 is configured to generate light 122a, which is projected towards aircraft engine 200 (or one or more components thereof). In aspects, light 122a is comprised of a broadband visible spectrum (e.g., 400-700 nm). However, it is contemplated that light 122a may vary in wavelength and include any single, multiple, or broadband spectral wavelengths of the electromagnetic spectrum. For example, light 122a may include the ultraviolet spectrum (e.g., 300-400 nm), the visible spectrum (e.g., 400-700 nanometers) and/or the infrared spectrum (e.g., 700-1,000,000 nanometers). Typically, the infrared spectrum includes near-infrared (NIR) (e.g., 700-1,400 nanometers), short-wave infrared (SWIR) (e.g., 1,400-3,000 nanometers), and/or mid-infrared (MIR) (e.g., 3,000-5,000 nanometers). In aspects, illumination source 120 may include an adjustable brightness, permitting a user to control the intensity and/or wavelength of light 122a according to specific imaging needs.

Generally, illumination source 120 of aircraft engine diagnostic system 100 may be a high-power intensity light source, which is configured as a separable module from imaging device 110. For example, illumination source 120 may be a laser (e.g., solid-state laser or diode laser), arc lamp, light-emitting diode (LED) or array, high-intensity discharge (HID) lamp, tungsten-halogen lamp, and/or any other radiant flux emitter or combination thereof including with/without the use of waveguides and/or beam shaping optics. In aspects, illumination source 120 may be attached to and/or integrated with imaging device 110. For example, illumination source 120 may be a ring light (e.g., circular arrangement of LEDs) disposed around a lens of imaging device 110. In another example, an array (e.g., a ring or circular arrangement) of individual illumination sources 120 may be disposed around the imaging device 110 to provide uniform and consistent lighting across a field of view. The ring configuration of illumination source 120 ensures that light is evenly distributed, reducing shadows and minimizing glare, which can otherwise affect imaging accuracy. In doing so, the ring configuration maintains optimal reflection angles, particularly when imaging fast-moving or curved surfaces, such as the complex contours of fan blades. Additionally, the ring configuration enhances visibility under varying ambient lighting conditions and ensures that retroreflective surfaces receive consistent illumination from multiple angles, improving overall imaging precision.

Imaging device 110 and/or illumination source 120 of aircraft engine diagnostic system 100 may be aligned along an axis of an incident angle, along which light 122a can be projected onto aircraft engine 200 (or one or more components thereof). Retroreflectors 140 can reflect a portion of light 122a back to imaging device 110 and/or illumination source 120 as retroreflective light 122b detected by imaging device 110.

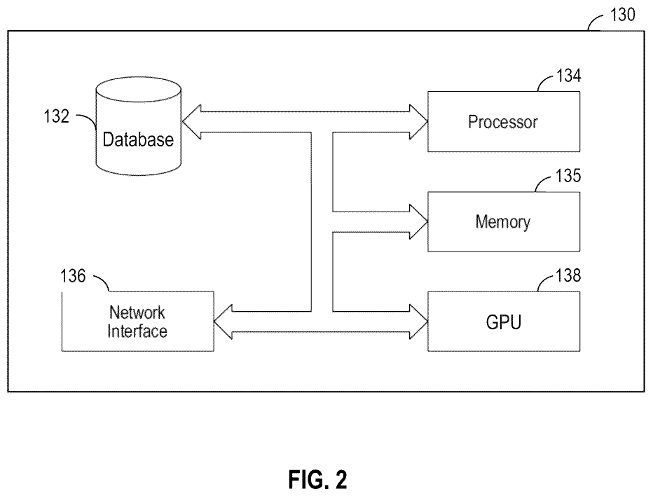

Referring now to FIG. 2, exemplary components in the controller 130 in accordance with aspects of the present disclosure include, for example, a database 132 (e.g., storage), one or more processors 134, at least one memory 135, and a network interface 136. In aspects, the controller 130 may include a graphical processing unit (GPU) 138, which may be used for processing machine learning network models.

Database 132 of controller 130 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In various aspects, data may be stored on controller 130, including, for example, user preferences, historical data, and/or other data. The data can be stored in database 132 and sent via the system bus to processor 134.

Processor 134 of controller 130 executes various processes utilizing the data from database 132 based on instructions that can be stored in the memory 135. A request from a user device, such as a mobile device or a client computer, can be communicated to the server through the server's network interface 136. The illustration of FIG. 2 is exemplary, and controller 130 can include any other suitable components that may exist in a controller 130. Such other components are not illustrated in FIG. 2 for clarity of illustration.

With reference to FIG. 3, aircraft engine 200 can include a plurality of fan blades 210 extending radially outward from a hub 212. Aircraft engine 200 includes an open fan, although traditional, closed fan configurations (e.g., ducted or unducted) may also be used. In aspects, aircraft engine 200 may include propellors, tiltrotors, main rotors, tail rotors, and/or other rotors used in aerospace and capable of generating lift and/or propulsion.

One or more fan blades 210 of aircraft engine 200 support one or more retroreflectors 140. As used herein, a “retroreflector” is an optical device, which returns incident light back to a source regardless of the angle of incidence, producing significantly brighter reflected light. As shown in FIG. 3, retroreflectors 140 reflect at least a portion of light 122a directly back to imaging device 110 in order to image and/or track the motion of aircraft engine 200 (or one or more components thereof) (e.g., motion of blades 210). In doing so, at least a portion of light 122a incident on retroreflectors 140 is reflected back to imaging device 110 and/or illumination source 120 as retroreflective light 122b (e.g., reflected light) with a small divergent cone.

Thus, when illuminating retroreflectors 140 with illumination source 120 (e.g., on-axis), a high-speed camera such as imaging device 110 may process retroreflective light 122b as an area of significantly higher intensity compared to its surroundings. For example, retroreflective light 122b may appear tens to thousands of times more intense compared to omnidirectional light (e.g., ambient and/or Lambertian light reflected off a diffuse or matte surface) or specular and/or semi specular light (e.g., directional light angled away from the incident angle creating defined beams). This provides a benefit over traditional means of object and/or area contrasting in ground evaluation and/or manufacturing, as it permits higher speed frame rates, improved object tracking, and higher intensity visuals via imaging device 110 without the need for additional equipment, such that the retroreflectors improve reflectivity and/or contrast in resulting imaging.

Retroreflectors 140 of aircraft engine diagnostic system 100 may be fabricated as a polymer film tape in a variety of colors, which are configured to conform to the shape of the surface on which they are placed on, e.g., blades 210. This provides a benefit over traditional paint-based methods of aerospace component tracking, as the tape retroreflectors 140 offer flexibility in number, placement, and size of retroreflectors 140 placed on blades 210, while retaining the advantages of color-coordinated tracking. Such flexibility may be particularly advantageous during ground evaluation and/or manufacturing, as size and/or placement of retroreflectors 140 may vary greatly based on factors such as spot size dimensions and/or film dimensions. Retroreflectors 140 are affixed to blades 210 using any suitable securement technique such as machining, welding, fastening, friction-fit, adhesives, etc. For instance, retroreflectors 140 can be secured using any suitable adhesive such as epoxy, polyurethane, and/or pressure-sensitive adhesives. In aspects, retroreflectors 140 may be removeable to easily adjust a position on blades 210. In aspects, retroreflectors 140 may be fabricated from various alternative natural or synthetic materials, such as other polymers (e.g., elastomers), metals, and/or ceramics. In aspects, retroreflectors 140 are placed onto the surface of a substrate (e.g., blades 210), embedded into a substrate, and/or fabricated directly into a substrate.

With further reference to FIG. 3, retroreflectors 140 of aircraft engine diagnostic system 100 may be affixed to blades 210 in various arrangements, grouping, and/or patterns based on an area of interest to monitor, dictating an optimal area of the deflection signal for imaging. For example, retroreflectors 140 may be placed on a free end portion of blade 210, a fixed end portion of blade 210, and/or an intermediate portion of blade 210 that extends between the fixed and free end portions of blade 210. The free end portion extends radially farther outward from the longitudinal axis “L” of the aircraft engine 200 than the fixed end portion of the blade 210 with the fixed end portion of the blade 210 connecting to hub 212.

Retroreflectors 140 of aircraft engine diagnostic system 100 may be arranged on any rotating portion of a substrate capable of being monitored through high-speed imaging in any arrangement of positions and/or colors. In aspects, retroreflectors 140 of aircraft engine diagnostic system 100 are arranged in any suitable arrangement on, for example, a free end portion and/or an intermediate portion on one or more blades 210, which, in aspects, includes one or more patterns, and/or which is wholly or partially random, and/or which is predetermined. For example, as seen in FIG. 3, retroreflectors 140 may be positioned in an alternating pattern on alternating free end portions of blades 210. Indeed, in aspects, the retroreflectors 140 may be disposed adjacent to one another on a blade 210 or on adjacent blades 210, opposite to one another on a blade 210 or on opposing blades 210, spaced by multiple blades, and/or combinations thereof, and/or any other suitable arrangement. In another example, retroreflectors 140 may cover an entire surface of one or more blades 210 (and/or one or more portions of one or more surfaces of the one or more blades 210). In aspects, arrangements of retroreflectors 140 may include highly visible, contrasting colors (e.g., yellow, green, orange, and red), neutral colors (e.g., white, silver) and/or specific patterns (e.g., checkboard, stripes, dots) to enhance the visibility and/or accuracy of aircraft engine diagnostic system 100 under dynamic conditions. In aspects, imaging device 110 is configured to capture performance of blades 210 for ground evaluation and/or manufacturing. According to an example, imaging device 110 captures a rate of rotation of blades 210. In one example, a rapid oscillation or vibration causes blades 210 to appear blurred, deformed (e.g., bent or twisted), and/or visibly damaged (e.g., visible cracks, material fatigue) when captured by imaging device 110. In aspects, additional sensors (not shown) may be incorporated into aircraft engine diagnostic system 100 to measure sudden changes in performance parameters such as thrust, torque, and/or power output.

In aspects of this disclosure, aircraft engine diagnostic system 100 outputs an alert indicating performance metrics. In some aspects of this disclosure, the alert includes a haptic, visual, and/or auditory cue. In one example, aircraft engine diagnostic system 100 indicates a rotational speed of blades 210 and/or an amount of deformation of components in order to implement an operating speed at a lower threshold. In another example, a vibrational pattern is emitted. In still another example, a specific sound e.g., a high-pitched humming, is played for further analysis. According to one aspect of this disclosure, the alert is output from a component of aircraft engine diagnostic system 100 and/or a standalone device, such as a smartphone, tablet, laptop, e-reader, smartwatch, and/or virtual reality (VR) headset.

Based on their highly reflective and predictable properties, retroreflectors 140 are configured to analyze the behavior of blades 210 in real-time. In use, imaging device 110 is configured to track the motion of retroreflectors 140 via retroreflective light 122b, which is converted to voltage (e.g., via an amplifier) for processing to identify vibrational patterns of, for example, fan blades 210 of aircraft engine 200. Specifically, using retroreflectors 140, imaging device 110 is configured to capture the performance data of one or more components of aircraft engine 200 (e.g., fan blades 210 of aircraft engine 200).

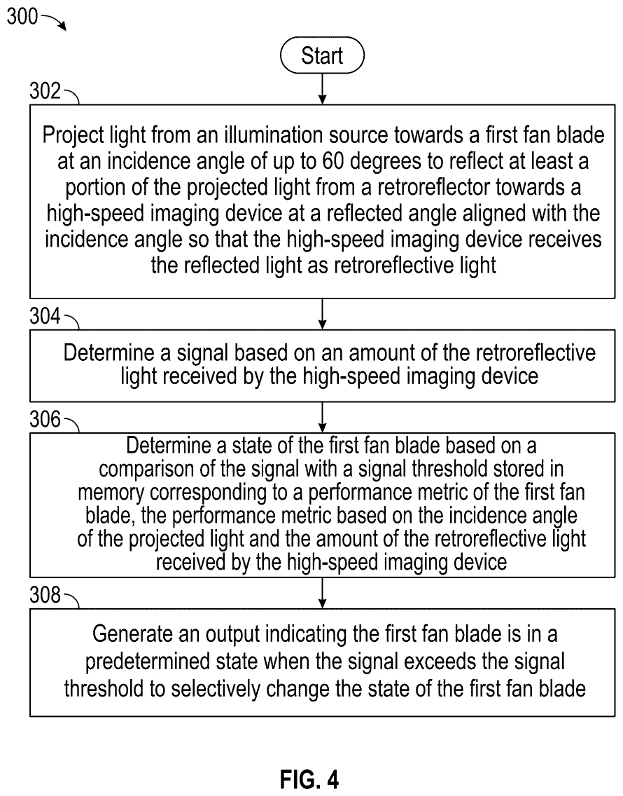

With reference to FIG. 4, a flow diagram for a method 300 of evaluating aircraft components of an aircraft engine 200 (FIG. 3) with the aircraft engine diagnostic system 100 (FIG. 1) is shown. Although the steps of FIG. 4 are shown in a particular order, the steps need not all be performed in the specified order, and certain steps can be performed in another order. For example, FIG. 4 will be described below, with a controller 130 (FIG. 1) performing the operations. In various aspects, the operations of FIG. 4 may be performed all or in part by the controller 130 of FIG. 1. In aspects, the operations of FIG. 4 may be performed all or in part by another device, for example, a mobile device and/or a remote computer system. These and other variations are contemplated to be within the scope of the present disclosure.

Initially, at step 302, the controller 130 of the aircraft engine diagnostic system 100, which is operably coupled to the illumination source 120, causes the aircraft engine diagnostic system 100 to project light 122a from an illumination source 120 towards a first fan blade 210 at an incidence angle of up to 60 degrees to reflect at least a portion of the projected light from a retroreflector towards a high-speed imaging device at a reflected angle aligned with the incidence angle so that the high-speed imaging device receives the reflected light as retroreflective light. In aspects, the aircraft engine diagnostic system 100 may project light 122a from the illumination source towards a portion of the aircraft engine 200 (e.g., towards any one or more components thereof on which a retroreflector 140 is disposed). In one example, a corner cube and/or prismatic retroreflector is affixed to a surface of a fan blade 210, and a user may set up a camera and lighting some distance away, e.g., approximately 20 feet away, from the fan blade 210 for imaging the fan blade 210 when the aircraft engine 200 is running. The retroreflector 140 may be a flexible or rigid retroreflector. For example, a rigid retroreflector designed for durability in rugged terrain may be laser cut and embedded into fan blades 210 (e.g., using epoxy or any other suitable adhesive material and/or any other suitable securement technique). Prior to image recording, the user may activate the lighting to illuminate the fan blade 210. Such light 122a is configured to project towards retroreflector 140 at an incidence angle “IA” (FIG. 3). In one example, light 122a is projected from illumination source 120 at an incidence angle “IA” of 20° relative to optical axis “A” (FIG. 3). The incidence angle of light 122a may vary based on the type of retroreflector used in order to optimize retroreflection. For example, the incidence angle of light 122a may be up to 60 degrees.

Generally, light 122a is broadband light and/or white light in the visible spectrum having a wavelength range of about 400-700 nanometers, although light 122a can include any spectrum or combined spectra of light capable of illuminating portions of aircraft engine 200 (or one or more components thereof). Illumination source 120 may be disposed in a colinear relationship with imaging device 110. For example, a user may activate an LED ring light positioned about a lens of a high-speed camera such that a stream of light is projected towards a retroreflector in preparation for ground evaluation.

In aspects, illumination source 120 of aircraft engine diagnostic system 100 includes pre-defined and/or adjustable settings. For example, a user may toggle a lever, or similar device, (not shown) to adjust a level of brightness of light 122a. A user may also select a pre-defined setting on an external device, e.g., a mobile or connected device, which automatically adjusts light 122a based on a selected evaluation phase, environment, and/or time of day. For instance, the user may select “indoor ground evaluation” and a “nighttime” setting, which will adjust an intensity and/or bandwidth of wavelengths of light 122a to compensate for lower natural light levels. Alternatively, illumination source 120 may include sensors (not shown) configured to automatically adjust a brightness of light 122a based on sensed light measurements in the environment. In another example, a user may load custom settings from a profile on a mobile or connected device based on their past evaluation and/or preferences, e.g., a bandwidth of wavelengths.

The retroreflector 140 of aircraft engine diagnostic system 100 reflects the projected light 122a (or a portion thereof) back to imaging device 110 as retroreflective light 122b. The imaging device 110 is operably coupled to controller 130. The incidence angle (“IA” of FIG. 3) of retroreflective light 122b is up to 60 degrees. Generally, a reflection angle of the retroreflective light 122b (e.g., angle at which light is projected back to imaging device 110) is aligned with the original incidence angle. For example, illumination source 120 projects light 122a towards aircraft engine 200 (or one or more components thereof) and retroreflector 140 (e.g., corner cube) on aircraft engine 200 (or one or more components thereof) reflect, for example, about 30-40% of the maximum possible light 122a back in the direction of the source encompassed in a divergent cone, such that imaging device 110 captures a portion of retroreflective light 122b (e.g., a detected portion of the divergent cone incident on collecting optics of the imaging device 110). In this regard, the portion of aircraft engine 200 where retroreflector 140 was placed (e.g., fan blade 210) becomes significantly illuminated.

In one example, a first fan blade 210 containing a corner cube retroreflector may appear 1000× brighter than surrounding blades without any retroreflectors. In aspects, brightness varies based on factors including reflectivity, albedo, surface finish, observation angle, distance, and/or light wavelength. For example, if a user is closer to a fan blade 210 and/or or at a low observation angle (e.g., generally aligned with illumination source 120), the fan blade 210 may appear significantly brighter to the user compared with when the user is farther away from the fan blade 210 and/or at a higher observation angle. In aspects, a user may also adjust the incidence angle of the projected light 122a to emphasize/deemphasize a particular portion of aircraft engine 200 and/or fan blade 210 for imaging. For example, by decreasing the incidence angle to 50 degrees, the portion of light 122a reflected back to imaging device 110 as retroreflective light 122b, in some instances, increases by, for example, 10% or greater, thereby enabling fan blade 210 to appear significantly brighter.

The aircraft engine diagnostic system 100 receives a portion of the retroreflective light 122b and the imaging device 110 converts retroreflective light 122b into electrical signals (e.g., voltage) for processing by controller 130, enabling the capture of high-speed images and producing detailed, high-resolution images for analysis.

In aspects, imaging device 110 of aircraft engine diagnostic system 100 may be a camera containing a charge-coupled device (CCD) sensor, which receives retroreflective light 122b through a lens of the camera. The CCD may include an array of tiny, light-sensitive pixels configured to capture and convert photons of retroreflective light 122b into electrical charges. These electrical charges may be converted into voltage by an amplifier, sent to an analog-to-digital converter (ADC) for digitization, and/or processed by an image processor for subsequent analysis, storage, and display. In some aspects, the amplifier, ADC, and/or image processor may be located within imaging device 110, controller 130, and/or an external device such as a mobile device.

Next, at step 304, the controller 130 of the aircraft engine diagnostic system 100 causes the aircraft engine diagnostic system 100 to determine a signal based on an amount of the retroreflective light 122b received by the imaging device 110. The signal may correspond to the amount of the retroreflective light received by the imaging device 110 to a performance metric of one or more components of aircraft engine 200 during operation. This signal is generally based on the digitized light, e.g., image data, received in step 306, which may indicate a variety of performance measurements of aircraft engine 200 (or one or more components thereof). For example, image data may include a set of vibrational characteristics of blades 210, such as specific amplitudes, frequencies, and/or phases of the vibrations during ground evaluation and/or manufacturing.

In another example, image data may include a set of visual characteristics of blades 210, such as blurring, deformation, and/or defects therein. In another example, a separate sensor may record a set of sound characteristics of blades 210, such as characteristic whistling or humming sounds, and/or overall increased ambient noise levels. These characteristic data sets may be stored within imaging device 110, controller 130, and/or an external device such as a mobile device for further processing and analysis.

Next, at step 306, the controller 130 of the aircraft engine diagnostic system 100 causes the aircraft engine diagnostic system 100 to determine a state (e.g., a condition) of the first fan blade 210 based on a comparison of the signal (e.g., signal determined in step 306) with a signal threshold stored in memory 135 corresponding to a performance metric of the first fan blade 210, where the performance metric is based on (e.g., determined by) the incidence angle of the projected light and/or the amount of retroreflective light received by the imaging device 110. In aspects, the performance metric may be based on a wavelength of the projected light. In aspects, the aircraft engine diagnostic system 100 may determine a state and/or condition of a portion of aircraft engine 200 (e.g., any one or more components thereof). In aspects, the signal threshold may be a predetermined signal threshold, and the performance metric may be a predetermined performance metric (e.g., preset in a system based on a user setting, previous diagnostics, reports, and/or data, and/or determined by AI/ML).

Controller 130 may compare a vibration signature of blades 210 during ground evaluation and/or manufacturing with a vibration signature of industry-standard blades. In aspects, the vibration signature includes a specific pattern of vibrations and/or vibration wavelengths which, if exceeding and/or different from the industry standard signature, can be indicative of a current deformation state that can affect current or future performance of blades 210. The controller 130 can utilize this vibration signature in conjunction with, or separate from, the signals and/or data related to the amount of retroreflective light received by the imaging device 110 to facilitate a determination by the controller 130 about the state or condition of aircraft engine 200.

In one aspect, controller 130 of aircraft engine diagnostic system 100 compares a noise signature emitted by blades 210, such as an increase in volume of a noise during ground evaluation and/or manufacturing, with a noise signature emitted by industry-standard blades. The noise signature, if exceeding and/or different from the industry standard signature, can indicate deformations within blades 210, which require immediate repair. Alternatively, rather than performing a comparison, aircraft engine diagnostic system 100 is preprogrammed to listen for a specific trigger noise, such as specific, high-pitch whistling. Again, the controller 130 can utilize this noise signature in conjunction with, or separate from, the vibration signatures and/or the signals and/or data related to the amount of retroreflective light received by the imaging device 110 to facilitate a determination by the controller 130 about the state or condition of aircraft engine 200.

Finally, at step 308, the controller 130 of the aircraft engine diagnostic system 100 causes the aircraft engine diagnostic system 100 to generate an output indicating the first fan blade 210 is in a predetermined state when the signal exceeds the signal threshold (e.g., based on the comparison in step 306) to selectively change the state of the first fan blade 210. In aspects, the aircraft engine diagnostics system 100 generates an output indicating that a portion of the aircraft engine 200 exceeds the signal threshold (e.g., any one or more components thereof). The output may be provided in the form of a recommendation or alert such as an audio, visual, and/or haptic alert, which may be displayed on imaging device 110 and/or a mobile device, such as a smartphone, tablet, laptop, e-reader, smartwatch, and/or virtual reality (VR) headset. This output can then be utilized, for example, to change, repair, or replace one or more components of the aircraft engine 200 (e.g., one or more of the fan blades, and/or the entire fan, etc.), and/or to change a state of the aircraft engine 200 (e.g., stop, speed-up, slow down, etc.) as described in additional detail below.

In aspects, aircraft engine diagnostic system 100 outputs an auditory alert via a speaker indicating excessive vibration of blades 210. The auditory alert may be a ringing, chirping, beeping, and/or other loud noise configured to alert the user. In aspects, the alert includes an option to replay the specific noise emitted from blades 210. In another example, aircraft engine diagnostic system 100 outputs a visual alert to a display showing a portion of blades 210 that is deformed. The visual alert may include still images and/or videos, which a user may replay and review for further analysis. In aspects, a viewable 360-degree model is generated for replaying the captured images of aircraft engine 200 (or one or more components thereof). In another example, aircraft engine diagnostic system 100 outputs haptic feedback to a mobile device, such as a vibrational feedback, force feedback, and/or surface haptics.

In aspects, aircraft engine diagnostic system 100 causes the aircraft engine 200 (or one or more components thereof) to selectively change a state or condition of one or more components of the aircraft engine 200. In one example, aircraft engine diagnostic system 100 causes the aircraft engine 200 (or one or more components thereof) to stop, start, change speed, change power, change voltage, change current, change direction, etc., and/or combinations thereof to enable further analysis, repair, and/or replacement of aircraft engine 200 or one or more components thereof (e.g., fan blades). In one example, the aircraft engine diagnostic system 100 causes such change in state or condition of the aircraft engine 200 (or one or more components thereof) when controller 130 of aircraft engine diagnostic system 100 determines the aircraft engine 200 (or one or more components thereof) is/are in or meet a predetermined or threshold state or condition in response to aircraft engine diagnostic system 100 retroreflecting light from one or more retroreflectors 140 of aircraft engine diagnostic system 100 when retroreflectors 140 are secured to aircraft engine 200 or one or more components thereof.

In aspects, the controller 130 of aircraft engine diagnostic system 100 causes the aircraft engine diagnostic system 100 to output additional performance metrics, characteristics, and/or alerts. For example, after alerting the user of a deformation state, a display of aircraft engine diagnostic system 100 indicates details regarding an exact rotational speed of blades 210 at the time the deformation state began (e.g., an inception time). In another example, a specific amount and/or location of deformation is displayed, e.g., on a free end or intermediate (e.g., mid-chord) portion of blades 210.

Retroreflectors 140 of aircraft engine diagnostic system 100 may include various micro-replicated optical structures configured to enhance visibility, facilitate precise measurements, and/or enable optical communication, which may vary based on the optimal intensity, orientation, and/or angular dependencies required. Generally, retroreflectors 140 are arranged to conform to a contour profile of a component of aircraft engine 200 (e.g., a fan blade(s)) to ensure optimal reflection while minimizing interference with aerodynamic properties of the component (e.g., air flow into the aircraft engine 200). Complex contours of retroreflectors 140 and/or fan blades 210 help to minimize aerodynamic disruptions and/or maintain proper airflow. As used herein, complex contours may refer to any number of non-uniform, curved, and/or multi-angled surfaces, which can vary in shape and/or orientation. For example, fan blades 210 can exhibit complex contours due to their twisted, tapered, and/or cambered geometry, which is designed for optimal aerodynamic performance. In the context of fan blades 210, complex contours may include blade camber (e.g., curvature from leading to trailing edge), blade torsion (e.g., twist along the span of the blade), blade taper (e.g., varying thickness from root to tip), surface texturing, and/or blade leading and trailing edges.

Various shapes and sizes of retroreflectors 140 are contemplated. In aspects, retroreflectors 140 may be flexible and configured to conform to the contoured surface of a component of aircraft engine 200, such as a fan blade 210. Thus, retroreflectors 140 are configured to maintain close contact with a component undergoing minor deformations during operation (e.g., deformation of a fan blade). Retroreflectors 140 may include prismatic and/or bead retroreflectors embedded in a polymer base, enabling the retroreflectors 140 to reflect light effectively despite slight bending. For example, retroreflectors 140 may be positioned on a flat and/or curved section of the fan blade 210 (e.g., leading or trailing edges) without protrusions and/or without significantly affecting aerodynamics due to the thin structure of the retroreflectors 140. In aspects, retroreflectors 140 are rigid and configured to maintain a precise geometry while corresponding to a contour of a component of aircraft engine, such as a fan blade 210. Thus, retroreflectors 140 can maintain enhanced durability and optical efficiency for a longer lifespan. In aspects, retroreflectors 140 may include prismatic and/or metallized retroreflectors for high optical efficiency. Retroreflectors 140 may be mechanically fastened, embedded, or bonded onto the component (e.g., permanent bonding). Retroreflectors 140 may be laser cut to a shape and/or embedded into a flat or curved section of the fan blade 210 (e.g., root or mid-chord) to reduce vibrational stress and/or prevent aerodynamic disturbances.

Several types of retroreflectors 140 were evaluated with aircraft engine 200 to determine optimal structure and input angles. Generally, retroreflectors 140 are corner cube retroreflectors (CCR), (e.g., prismatic retroreflectors), which are designed with three orthogonal surfaces intersecting at a corner. In aspects, retroreflector 140 includes coated (e.g., colorized), uncoated, and/or metallized surfaces. In one example, a colorized retroreflector 140 is coated with various thin-film coatings, colored polymer films, interference coatings, and/or dichroic filters, which provide enhanced durability, preservation of retro-reflectivity, and customization options over traditional paint coatings. In another example, an uncoated retroreflector 140 provides total internal reflection (TIR) and/or Fresnel reflection, which provide advantages over coated versions such as reduced weight enhanced durability. In another example, a metallized retroreflector 140 includes 3 mutually perpendicular reflective metal surfaces, with a polymer base underneath. In aspects, a metallized retroreflector 140 includes a color filtering topcoat.

In aspects, retroreflectors 140 include full cube prismatic retroreflectors (e.g., 3M™ Diamond Grade™). In some aspects, retroreflectors 140 include engineering-grade glass beads, which have a reflective metal surface. Overall, such retroreflectors are capable of returning retroreflective light 122b within 20 feet to several kilometers, providing a wide optical range. In one example, each type of retroreflector evaluated with fan blades 210 of an aircraft engine to analyze efficiency, input angle, and arbitrary orientation provide the following results:

| | Bead | Corner Cube | Full Cube |
|---|---|---|---|
| Efficiency | 15% | 35% | 58% |
| Input Angle | ±60° | ±45° | ±30-38° |
| Arbitrary | Yes | Yes | No |
| Orientation | | | |

P. Schultz, B. Cumby, & J. Heikenfeld, Investigation of Five Types of Switchable Retroreflector Films For Enhanced Visible And Infrared Conspicuity Applications, 51 APPL. OPT., 3744 (2012).

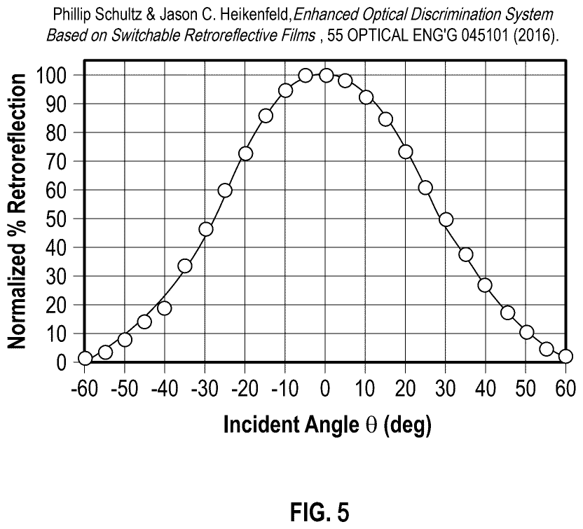

As shown above, and with reference to FIG. 5, the efficiency of retroreflectors 140 of aircraft engine diagnostic system 100 generally depends on the geometry of the retroreflectors 140. For example, using a corner cube reflector, a significant portion of light may refract and/or scatter rather than reflect back beyond a threshold input angle. Generally, retroreflectors 140 reflect light 122a as retroreflective light 122b at angles of up to 600 (input angle) relative to a plane defined by the surface of retroreflectors 140, which may vary based on the type of retroreflectors 140 used. Thus, when used on aircraft engine 200 (or one or more components thereof), retroreflectors 140 are consistent and predictable with interrogation incident angles up to a maximum practical angle of 60°, with the intensity and/or retroreflectivity properties of retroreflective light 122b tapering off thereafter depending on the structure of retroreflectors 140. This provides an enhanced imaging and/or safety feature, as individuals may predict a “zone” within which to capture the retroreflective light 122b. For example, in rotating components such as fan blades 210 of aircraft engine 200, it may not always be possible to position the illumination source 120 directly in line (e.g., colinear) with the imaging device 110. In addition, some testing scenarios require the illumination source 120 to be positioned at an angle due to physical obstructions, airflow, and/or safety reasons. Thus, the up to 60° angle provides the benefit of a practical and flexible range within which retroreflectors 140 may still effectively reflect light 122a as retroreflective light 122b.

In aspects, an offset illumination may be particularly advantageous. For example, if illumination source 120 is collinear with retroreflectors 140, retroreflective light 122b may generate a detrimentally strong signal, leading to oversaturation of imaging device 110 and difficulty detecting fine structural details (e.g., details in fan blades 210). Thus, at a wider angle, an intensity of retroreflective light 122b is lower but sufficient for tracking and balancing image contrast. In another example, if illumination source 120 is collinear with retroreflectors 140, retroreflective light 122b may have a very narrow cone, making it difficult to capture consistent retroreflective light 122b during rapid movement of a rotating component through a range of angles (e.g., rotating of fan blades 210). Thus, the wider angle of reflection increases the likelihood of capturing usable light during high-speed motion. In aspects, an offset angle may also help distinguish retroreflective light 122b from ambient lighting, such as background light interference or reflections from other surfaces.

In aspects, artificial intelligence (AI) such as machine learning (ML) algorithms may be used to enhance high-speed image tracking of aircraft engine 200 (or one or more components thereof) by improving the accuracy, efficiency, and/or robustness of the analysis process. For example, a convolutional neural network (CNN) can be trained to detect and analyze blades 210 in high-speed video footage. This provides a benefit over traditional tracking software, as AI such as a CNN can handle complex motion patterns and occlusions more effectively than present methods while filtering out noise. Moreover, an ML algorithm can automate the extraction of relevant features from high-speed footage, such as blade edge detection, deformation patterns, and/or vibration frequencies, thereby reducing the need for manual intervention and increasing the consistency of the analysis.

Such ML algorithms can be used to provide insights into the vibrational and/or noise characteristics of, for instance, blades 210, helping to identify potential issues and/or areas for improvement in installation and operation thereof. For example, ML models may predict future vibration and/or noise levels and/or potential failures of, for instance, blades 210 based on historical data. Moreover, ML models may define normal operational behavior and identify deviations in vibrational or noise patterns that indicate potential issues with, for instance, blades 210 and/or other aircraft components. Such ML models may be trained (e.g., continuously) with new data to improve their accuracy and/or adaptability to changing conditions.

Various additional implementations of AI with retroreflective enhanced high-speed imaging are contemplated and within the scope of this disclosure, including but not limited to ML, deep learning (e.g., recurrent neural networks (RNNs), generative adversarial networks (GANs), and/or computer vision algorithms.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ this disclosure in virtually any appropriately detailed structure.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Further aspects of the present disclosure are provided by the subject matter of the following clauses.

An aircraft engine diagnostic system comprises an aircraft engine, a high-speed imaging device, an illumination source, a processor, and a memory. The aircraft engine includes a plurality of fan blades and a retroreflector secured to a first fan blade of the plurality of fan blades, such that the retroreflector conforms to a contour profile of the first fan blade and is positioned to enable consistent airflow across the plurality of fan blades. The high-speed imaging device is configured to capture an image of the first fan blade of the aircraft engine. The memory is coupled to the processor and has instructions stored thereon, which when executed by the processor, cause the aircraft engine diagnostic system to: project light from the illumination source towards the first fan blade at an incidence angle of up to 60 degrees to reflect at least a portion of the projected light from the retroreflector towards the high-speed imaging device at a reflected angle aligned with the incidence angle so that the high-speed imaging device receives the reflected light as retroreflective light; determine a signal based on an amount of the retroreflective light received by the high-speed imaging device; determine a state of the first fan blade based on a comparison of the signal with a signal threshold stored in the memory corresponding to a performance metric of the first fan blade, the performance metric based on the incidence angle of the projected light and the amount of the retroreflective light received by the high-speed imaging device; and generate an output indicating the first fan blade is in a predetermined state when the signal exceeds the signal threshold to selectively change the state of the first fan blade.

The system of the preceding clause, wherein the illumination source includes a plurality of light sources arranged in a ring around the high-speed imaging device.

The system of any of the preceding clauses, wherein the retroreflector is disposed on a free end portion of the first fan blade.

The system of any of the preceding clauses, wherein the high-speed imaging device captures images at a frame rate of at least 60 frames per second (fps).

The system of any of the preceding clauses, wherein the high-speed imaging device is at least one of a charge-coupled device (CCD) sensor, a complementary metal-oxide-semiconductor (CMOS) sensor, or an infrared (IR) sensor.

The system of any of the preceding clauses, wherein the illumination source is disposed in a colinear relationship with the high-speed imaging device.

The system of any of the preceding clauses, wherein at least one wavelength of the projected light ranges from ultraviolet (UV) light to mid-infrared (IR) light.

The system of any of the preceding clauses, wherein the signal threshold corresponds to a rotation rate of the first fan blade.

The system of any of the preceding clauses, wherein the output includes at least one of a visual, a haptic, or an auditory alert.

The system of any of the preceding clauses, wherein the instructions, when executed by the processor, further cause the aircraft engine diagnostic system to output an alert on a display, wherein the alert includes at least one of a rate of rotation or an amount of deformation of the first fan blade.

The system of any of the preceding clauses, wherein a structure of the retroreflector includes at least one of a corner cube retroreflector, a glass bead retroreflector, or a full cube retroreflector, and wherein a form of the retroreflector is at least one of a tape, a panel, or a paint.

The system of any of the preceding clauses, wherein the retroreflector is disposed on at least one of a free end portion or an intermediate portion of the first fan blade.

An aircraft engine diagnostic system comprises an aircraft engine, a high-speed imaging device, an illumination source, a processor, and a memory. The aircraft engine includes a plurality of fan blades and a plurality of retroreflectors. A first retroreflector of the plurality of retroreflectors is secured to a first fan blade of the plurality of fan blades and a second retroreflector of plurality of retroreflectors is secured to a second fan blade of the plurality of fan blades such that the first and second retroreflectors conform to respective contour profiles of the respective first and second fan blades. The first and second retroreflectors are each positioned such that consistent airflow is maintained across the plurality of fan blades. The high-speed imaging device is configured to capture an image of the aircraft engine. The memory id coupled to the processor and has instructions stored thereon, which when executed by the processor, cause the aircraft engine diagnostic system to: project light from the illumination source towards the plurality of fan blades at an incidence angle of up to 60 degrees to reflect at least a portion of the projected light from the plurality of retroreflectors towards the high-speed imaging device at a reflected angle so that the high-speed imaging device receives the reflected light as retroreflective light; determine a signal based on an amount of the retroreflective light received by the high-speed imaging device; determine a state of the plurality of fan blades based on a comparison of the signal with a signal threshold stored in the memory corresponding to a performance metric of the plurality of fan blades, the performance metric based on the incidence angle of the projected light and the amount of the retroreflective light received by the high-speed imaging device; and generate an output indicating the plurality of fan blades are in a predetermined state when the signal exceeds the signal threshold to selectively change the state of the plurality of fan blades.

The system of the preceding clause, wherein the illumination source includes a plurality of light sources arranged in a ring around the high-speed imaging device.

The system of any of the preceding clauses, wherein at least a third fan blade is disposed between the first and second fan blades of the plurality of fan blades such that the first and second retroreflectors are separated by at least one fan blade disposed between the first and second fan blades.

The system of any of the preceding clauses, wherein the first and second fan blades are disposed adjacent to one another such that no fan blade is disposed between the first and second fan blades.

The system of any of the preceding clauses, wherein at least two different retroreflectors are secured to the first fan blade.

The system of any of the preceding clauses, wherein at least one of the plurality of retroreflectors is secured to a free end portion of one of the plurality of fan blades.

The system of any of the preceding clauses, wherein the reflected angle is aligned with the incidence angle.

An aircraft engine diagnostic system comprises a gas turbine engine, at least one retroreflector, a high-speed imaging device, a retroreflector, an illumination source, a processor, and a memory. The gas turbine engine includes at least one fan blade and at least one retroreflector secured to the at least one fan blade, the at least one retroreflector corresponding to a contour profile of the at least one fan blade. The at least one retroreflector is secured to the at least one fan blade, the at least one retroreflector corresponding to a contour profile of the at least one fan blade. The high-speed imaging device is configured to capture an image of at least a portion of the at least one fan blade. The retroreflector is secured to the portion of the at least one fan blade, the retroreflector corresponding to a contour profile of the at least one fan blade. The memory is coupled to the processor and has instructions stored thereon, which when executed by the processor, cause the aircraft engine diagnostic system to: project light from the illumination source towards the at least one fan blade at an incidence angle of up to 60 degrees to reflect at least a portion of the projected light from the retroreflector towards the high-speed imaging device at a reflected angle so that the high-speed imaging device receives the reflected light as retroreflective light; determine an amount of the retroreflective light received by the high-speed imaging device; determine a state of the at least one fan blade based on a comparison of the amount of the retroreflective light received by the high-speed imaging device with a performance metric of the at least one fan blade, the performance metric based on the incidence angle of the projected light and the amount of the retroreflective light received by the high-speed imaging device; and generate an output indicating the at least one fan blade is in a predetermined state when the amount of the retroreflective light received by the high-speed imaging device is outside the performance metric to enable the state of the at least one fan blade to be selectively changed to provide the at least one fan blade within the performance metric.

It should be understood that the description herein is only illustrative of this disclosure. Various alternatives and modifications can be devised by those skilled in the art without departing from this disclosure. Accordingly, this disclosure is intended to embrace all such alternatives, modifications, and variances. The aspects described are presented only to demonstrate certain examples of this disclosure. Other elements, steps, methods, and techniques that are insubstantially different from those described above and/or in the appended claims are also intended to be within the scope of this disclosure.

What is claimed is:

1. An aircraft engine diagnostic system comprising:
an aircraft engine including a plurality of fan blades and a retroreflector secured to a first fan blade of the plurality of fan blades such that the retroreflector conforms to a contour profile of the first fan blade and is positioned to enable consistent airflow across the plurality of fan blades;
a high-speed imaging device configured to capture an image of the first fan blade of the aircraft engine;
an illumination source;
a processor; and
a memory coupled to the processor and having instructions stored thereon, which when executed by the processor, cause the aircraft engine diagnostic system to:
project light from the illumination source towards the first fan blade at an incidence angle of up to 60 degrees to reflect at least a portion of the projected light from the retroreflector towards the high-speed imaging device at a reflected angle aligned with the incidence angle so that the high-speed imaging device receives the reflected light as retroreflective light;
determine a signal based on an amount of the retroreflective light received by the high-speed imaging device;
determine a state of the first fan blade based on a comparison of the signal with a signal threshold stored in the memory corresponding to a performance metric of the first fan blade, the performance metric based on the incidence angle of the projected light and the amount of the retroreflective light received by the high-speed imaging device; and
generate an output indicating the first fan blade is in a predetermined state when the signal exceeds the signal threshold to selectively change the state of the first fan blade.

2. The aircraft engine diagnostic system of claim 1, wherein the illumination source includes a plurality of light sources arranged in a ring around the high-speed imaging device.

3. The aircraft engine diagnostic system of claim 1, wherein the retroreflector is disposed on a free end portion of the first fan blade.

4. The aircraft engine diagnostic system of claim 1, wherein the high-speed imaging device captures images at a frame rate of at least 60 frames per second (fps).

5. The aircraft engine diagnostic system of claim 1, wherein the high-speed imaging device is at least one of a charge-coupled device (CCD) sensor, a complementary metal-oxide-semiconductor (CMOS) sensor, or an infrared (IR) sensor.

6. The aircraft engine diagnostic system of claim 1, wherein the illumination source is disposed in a colinear relationship with the high-speed imaging device.

7. The aircraft engine diagnostic system of claim 1, wherein at least one wavelength of the projected light ranges from ultraviolet (UV) light to mid-infrared (IR) light.

8. The aircraft engine diagnostic system of claim 1, wherein the signal threshold corresponds to a rotation rate of the first fan blade.

9. The aircraft engine diagnostic system of claim 1, wherein the output includes at least one of a visual, a haptic, or an auditory alert.

10. The aircraft engine diagnostic system of claim 1, wherein the instructions, when executed by the processor, further cause the aircraft engine diagnostic system to:
output an alert on a display, wherein the alert includes at least one of a rate of rotation or an amount of deformation of the first fan blade.

11. The aircraft engine diagnostic system of claim 1, wherein a structure of the retroreflector includes at least one of a corner cube retroreflector, a glass bead retroreflector, or a full cube retroreflector, and wherein a form of the retroreflector is at least one of a tape, a panel, or a paint.

12. The aircraft engine diagnostic system of claim 1, wherein the retroreflector is disposed on at least one of a free end portion or an intermediate portion of the first fan blade.

13. An aircraft engine diagnostic system comprising:
an aircraft engine including a plurality of fan blades and a plurality of retroreflectors, wherein a first retroreflector of the plurality of retroreflectors is secured to a first fan blade of the plurality of fan blades and a second retroreflector of plurality of retroreflectors is secured to a second fan blade of the plurality of fan blades such that the first and second retroreflectors conform to respective contour profiles of the respective first and second fan blades, and wherein the first and second retroreflectors are each positioned such that consistent airflow is maintained across the plurality of fan blades;
a high-speed imaging device configured to capture an image of the aircraft engine;
an illumination source;
a processor; and
a memory coupled to the processor and having instructions stored thereon, which when executed by the processor, cause the aircraft engine diagnostic system to:
project light from the illumination source towards the plurality of fan blades at an incidence angle of up to 60 degrees to reflect at least a portion of the projected light from the plurality of retroreflectors towards the high-speed imaging device at a reflected angle so that the high-speed imaging device receives the reflected light as retroreflective light;
determine a signal based on an amount of the retroreflective light received by the high-speed imaging device;
determine a state of the plurality of fan blades based on a comparison of the signal with a signal threshold stored in the memory corresponding to a performance metric of the plurality of fan blades, the performance metric based on the incidence angle of the projected light and the amount of the retroreflective light received by the high-speed imaging device; and
generate an output indicating the plurality of fan blades are in a predetermined state when the signal exceeds the signal threshold to selectively change the state of the plurality of fan blades.

14. The aircraft engine diagnostic system of claim 13, wherein the illumination source includes a plurality of light sources arranged in a ring around the high-speed imaging device.

15. The aircraft engine diagnostic system of claim 13, wherein at least a third fan blade is disposed between the first and second fan blades of the plurality of fan blades such that the first and second retroreflectors are separated by at least one fan blade disposed between the first and second fan blades.

16. The aircraft engine diagnostic system of claim 13, wherein the first and second fan blades are disposed adjacent to one another such that no fan blade is disposed between the first and second fan blades.

17. The aircraft engine diagnostic system of claim 13, wherein at least two different retroreflectors are secured to the first fan blade.

18. The aircraft engine diagnostic system of claim 13, wherein at least one of the plurality of retroreflectors is secured to a free end portion of one of the plurality of fan blades.

19. The aircraft engine diagnostic system of claim 13, wherein the reflected angle is aligned with the incidence angle.

20. An aircraft engine diagnostic system comprising:
a gas turbine engine including at least one fan blade and at least one retroreflector secured to the at least one fan blade, the at least one retroreflector corresponding to a contour profile of the at least one fan blade;
at least one retroreflector secured to the at least one fan blade, the at least one retroreflector corresponding to a contour profile of the at least one fan blade;
a high-speed imaging device configured to capture an image of at least a portion of the at least one fan blade;
a retroreflector secured to the portion of the at least one fan blade, the retroreflector corresponding to a contour profile of the at least one fan blade;
an illumination source;
a processor; and
a memory coupled to the processor and having instructions stored thereon, which when executed by the processor, cause the aircraft engine diagnostic system to:
project light from the illumination source towards the at least one fan blade at an incidence angle of up to 60 degrees to reflect at least a portion of the projected light from the retroreflector towards the high-speed imaging device at a reflected angle so that the high-speed imaging device receives the reflected light as retroreflective light;
determine an amount of the retroreflective light received by the high-speed imaging device;
determine a state of the at least one fan blade based on a comparison of the amount of the retroreflective light received by the high-speed imaging device with a performance metric of the at least one fan blade, the performance metric based on the incidence angle of the projected light and the amount of the retroreflective light received by the high-speed imaging device; and
generate an output indicating the at least one fan blade is in a predetermined state when the amount of the retroreflective light received by the high-speed imaging device is outside the performance metric to enable the state of the at least one fan blade to be selectively changed to provide the at least one fan blade within the performance metric.
